(19) United States
(12) Patent Application Publication
(10) Pub. No.: US 2025/0244125 A1
(43) Pub. Date: Jul. 31, 2025

(54) LASER-GUIDED MAST ALIGNMENT SYSTEM AND METHOD

(71) Applicant: Roy Willis Poor, Jr., Groveport, OH (US)

(72) Inventor: Roy Willis Poor, Jr., Groveport, OH (US)

(21) Appl. No.: 19/040,200

(22) Filed: Jan. 29, 2025

Related U.S. Application Data
(60) Provisional application No. 63/630,391, filed on Jan. 29, 2024.

(51) Int. Cl. G01B 11/27; B63B 15/00

(52) U.S. Cl. CPC G01B 11/27; B63B 15/00; B63B 2015/005

(57) ABSTRACT

A system for mast alignment includes a mounting bracket assembly and a laser emitter connected to the bracket assembly. The bracket assembly mounts to a sailboat boom. The laser emitter projects a vertical laser beam along a length of a sailboat mast when the mounting bracket assembly is mounted to the sailboat boom. A method for mast alignment includes attaching the laser emitter to the bracket assembly; strapping the bracket assembly to the sailboat boom; projecting the vertical laser beam on a rear of the sailboat mast; and adjusting turnbuckles of shrouds and/or stays until the laser beam extends along a center of more than half of a height of the sailboat mast.

### CROSS-REFERENCE TO RELATED APPLICATION

This application claims the benefit of priority of U.S. provisional application No. 63/630,391, filed Jan. 29, 2024, the contents of which are herein incorporated by reference.

### BACKGROUND OF THE INVENTION

The present invention relates to a mast alignment system and method and, more particularly, to a laser-guided mast alignment system and method.

Sailboat mast alignment is performed to obtain a straight (side to side) mast column under sailing loads, so that the mast provides a uniform column to the aerodynamic foil (the sail) when compared between port tack and starboard tack, as well as to ensure that the mast column is centered in the sailboat. Alignment from front to back is typically not a concern because that adjustment can be made while sailing to adjust shape of the sail. Alignment of a sailboat mast to plumb, centered location in or on a sailboat is difficult. Typical methods of alignment involve swinging a tape or string from side to side and measuring the length between a point on the mast and reference points at the same distance from the mast. Thereafter-the entire process of alignment of the mast under dynamic loads is one of visual determination, approximation and often results in an inaccurate measurement. While some yachts, such as those that race in the America's Cup, as well as mega yachts, have established the use of mast mounted cameras to look at sail shapes, the concept of an inexpensive and relatively quick method towards a complete alignment and tuning of a mast under both static and dynamic loads has not been heretofore constructed.

U.S. Pat. No. 9,021,708B2 to Rabiner et al. describes a system for alignment of a sailboat mast including a mounting bracket attached to the mast, and one or more lasers pivotally connected to the mounting bracket. The lasers can be positioned at an index angle relative to the mast on both sides. The system can also include a laser mounted to the mast at a first height, and a beam splitter mounted at a second height closer to the bottom end of the mast than the first height. The beam splitter is positioned in alignment with the laser to split a laser beam emitted by the laser into multiple beams symmetrical relative to the mast. The Rabiner method for tuning of the mast includes one person adjusting the rigging, and another person adjusting and trimming the sails. The first person or an additional person defines the position of the mast. The system can require a vernier and calculation by trigonometry to quantify deflection and thereby produce an absolute measurement of the position change of the mast. This process is technical and difficult to set up properly. U.S. Pat. No. 9,021,708B2 is incorporated herein by reference in its entirety.

As can be seen, there is a need for a fast, simple method of aligning a sailboat mast.

### SUMMARY OF THE INVENTION

In one aspect of the present invention, a system for mast alignment comprises a mounting bracket assembly configured to mount to a sailboat boom; and a laser emitter connected to the mounting bracket assembly and configured to project a vertical laser beam along a length of a sailboat mast when the mounting bracket assembly is mounted to the sailboat boom.

In another aspect of the present invention, a method for mast alignment comprises attaching the laser emitter to the bracket assembly; strapping the bracket assembly to the sailboat boom; projecting a vertical laser beam on a rear of the sailboat mast; and adjusting turnbuckles of shrouds and/or stays until the vertical laser beam extends along a center of more than half of a height of the sailboat mast.

These and other features, aspects and advantages of the present invention will become better understood with reference to the following drawings, description, and claims.

### BRIEF DESCRIPTION OF THE DRAWINGS

FIG. 1 is a front elevation view of a sailboat mast alignment system according to an embodiment of the present invention;

FIG. 2 is a perspective view thereof;

FIG. 3 is a perspective view of a bracket assembly of the system of FIG. 1;

FIG. 4 is an exploded view thereof;

FIG. 5 is a rear detail view of the system of FIG. 1;

FIG. 6 is a detail view of a sailboat boom and mast, illustrating a use environment for the system of FIG. 1;

FIG. 7 is a schematic view of a sailboat, illustrating masts in out-of-alignment positions; and

FIG. 8 is a flowchart illustrating a method of aligning a sailboat mast according to another embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a laser-guided mast alignment system and method.

The term “laser” as used herein encompasses any device that emits light (electromagnetic radiation) such as through a process of optical amplification or a similar process.

The method of the present subject matter excludes use of a vernier or calculations to align a mast. The system of the present subject matter excludes use of an illumination spot with an optical target and excludes use of a beam splitter other than any intrinsically contained within the laser projector. Rather, the present system projects an elongated laser beam along the height of the mast. The present method excludes mounting a laser emitter to the mast. Generally, the laser emitter is mounted more than 12 inches from the mast on the boom.

The present method utilizes a projected laser beam or light source as a visual reference that can be used immediately to tune the mast. It uses a single projected plumb vertical reference light/beam. Using a visual reference light makes it easier and simpler to align or tune the rig/sailboat mast plumb in the boat. Because the projected self-leveling beam is always true and plumb, the shroud and stay adjustments can be used to center the mast in the boat.

Any suitable self-leveling light source that emits a visible laser beam or similarly focused beam of light may be used. For example, a battery-operated Elikliv PT0204A-G2 self-leveling cross line laser level, available from Amazon, may be used in the present system and method.

Any suitable attachment hardware may be used with the present system, including, for example, screws, nuts and bolts, thumbscrews, mated magnets, etc.

A bracket assembly mounts the projection laser level in such a way as to project a true and plumb light reference beam on the rear of the mast. The bracket assembly may be slidably mounted on the boom to adjust the device so that the laser contacts the full height of the mast.

To use the system, the user may attach the laser level or similar light source device to a boom attachment bracket assembly. The bracket assembly with the attached light source may be mounted to a sailboat boom, centered in the boat, using, for example, Velcro® hook and loop closure boom straps. Once the bracket assembly is mounted to the boom, the user may turn on the laser level/light source and point the projected beam/light at the center of the rear of the mast, moving the bracket assembly forward toward the bow of the boat or back toward the stern of the boat until the projected beam reaches the top of the mast. The mast can be plumbed or tuned using the vertical projected beam as a visual plumb (left and right) reference and using the shroud and stay turnbuckles to move the mast left and right until the center of the mast is centered on the reference beam from top to bottom. The mast is aligned when the mainsail track on the rear of the mast falls directly in line with the projected beam. Note that the present method does not rely on laser points or beam splitters and does not require any calculations in order to align the mast.

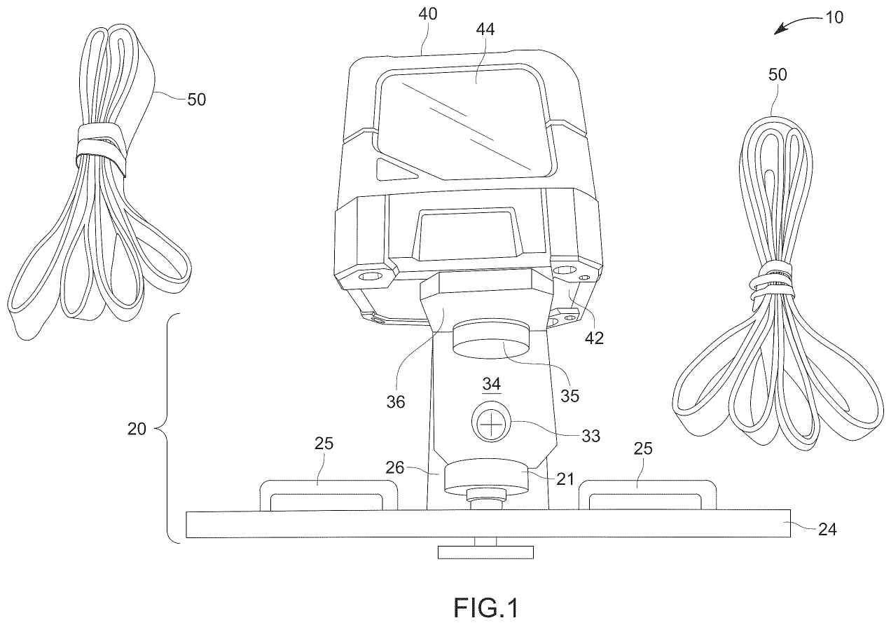

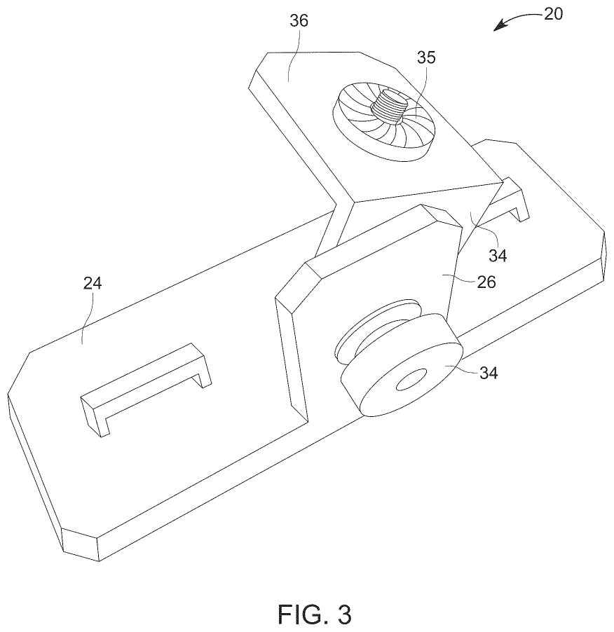

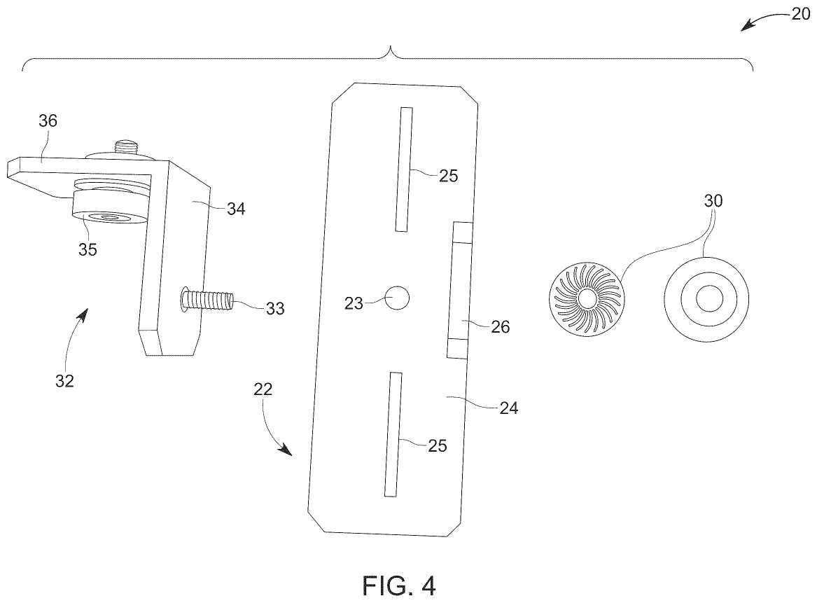

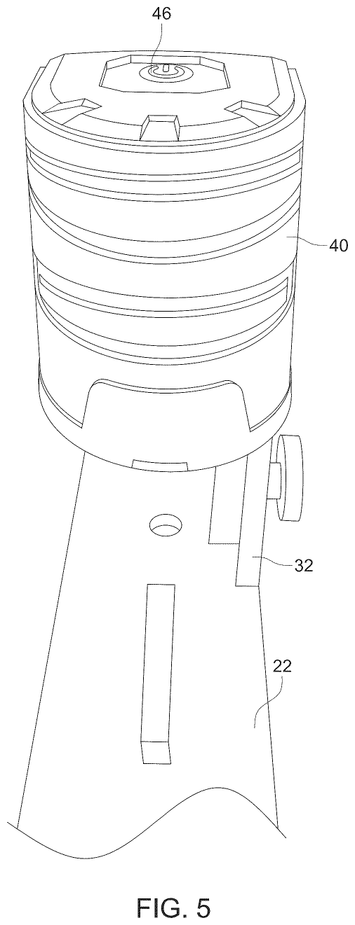

Referring to FIGS. 1-8, an alignment system 10 according to an embodiment of the present invention is illustrated in FIGS. 1-5. As shown in FIG. 1, a laser level or projector 40 is mounted to a bracket assembly 20 by way of fastening hardware 35. The fastening hardware 35 may include, for example, a nut and bolt set 30.

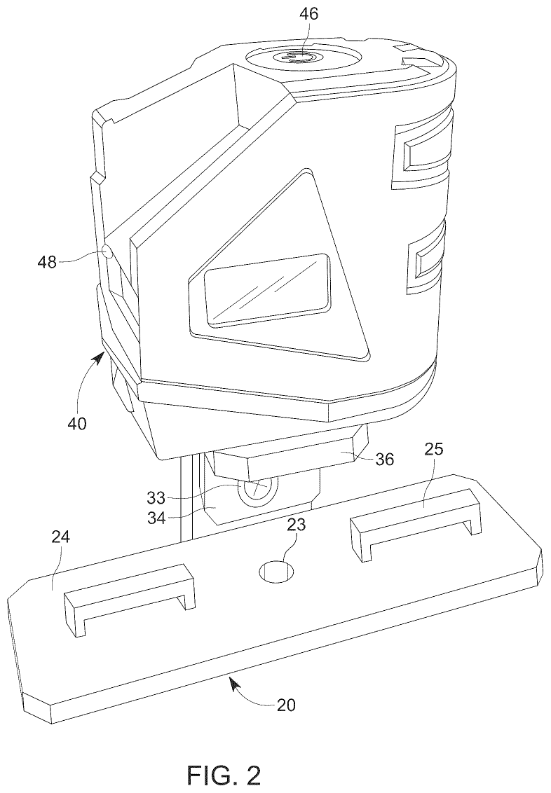

The laser level 40 may have a self-leveling base 42 and a display screen 44, as well as a power switch 46 and a laser diode 48 operative to emit a vertical laser beam; see FIG. 2.

The bracket assembly 20 generally comprises a boom attachment bracket 22 and an angle bracket 32 coupled to the boom attachment bracket 22 by way of attachment hardware 33. The boom attachment bracket 22 comprises an elongated base 24 with a post 26 extending from a midpoint of the base 24 and normal thereto. The base 24 has elevated slots 25 formed along the longitudinal axis of the base 24 evenly spaced to each side of the post 26. The angle bracket 32 comprises two bracket arms 34, 36 joined at a right angle. Attachment hardware 35 couples the bracket arm 36 to the laser level base 42. Attachment hardware 33 couples the vertical bracket arm 34 to the post 26. The boom attachment bracket may have a bore 23 through the center that accommodates attachment hardware 21; see FIG. 2.

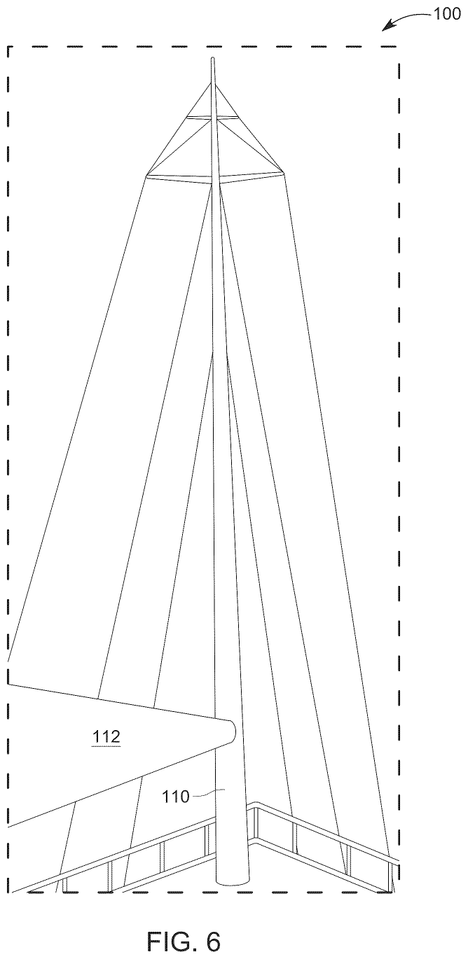

Straps 50, such as hook and loop closure straps, may be threaded through the slots 25 formed in the base 24 and are operative to fasten the system 10 to a sailboat boom 112; see FIG. 6.

A sailboat 100 having a mast 110 and a boom 112 is shown in FIG. 6. The system 10 may be strapped to the boom 112 with the laser diode 48 directed at the mast 110. The system 10 may be adjusted fore and aft until the laser beam (not shown) extends along the full height of the mast 110.

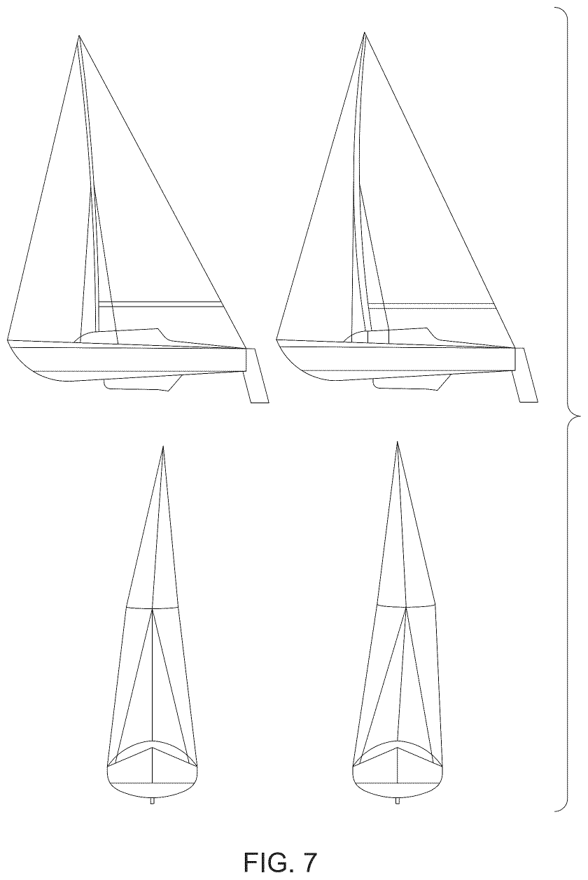

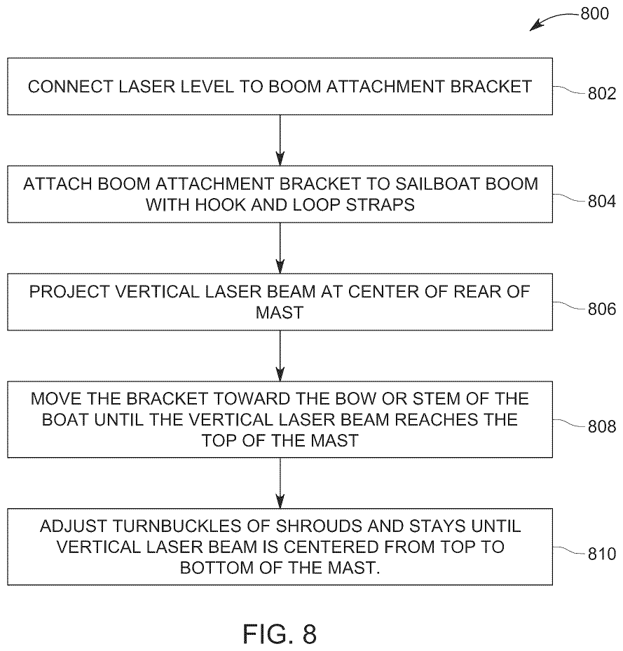

The present system may be used to correct misaligned masts, illustrated in FIG. 7, by a method according to another embodiment of the present invention and described in the flowchart 800 of FIG. 8. The laser level 40 may be connected 802 to the boom bracket assembly 20 and the boom attachment bracket 22 may be attached 804 to the sailboat boom 112. The laser level 40 may be actuated to project 806 a vertical laser beam at a center of the rear of the mast 110. The system 10 may be moved along the boom 112 until the laser beam extends along the full height of the mast 110. Turnbuckles of shrouds and stays may be adjusted 810 until the vertical laser beam is centered along the entire height of the mast 110.

It should be understood, of course, that the foregoing relates to exemplary embodiments of the invention and that modifications may be made without departing from the spirit and scope of the invention as set forth in the following claims.

What is claimed is:

1. A system for mast alignment, comprising:
a mounting bracket assembly configured to mount to a sailboat boom; and
a laser emitter connected to the mounting bracket assembly and configured to project a vertical laser beam along a length of a sailboat mast when the mounting bracket assembly is mounted to the sailboat boom.

2. The system of claim 1, wherein the mounting bracket assembly comprises an angle bracket and a boom mounting bracket having a base and a post extending from midway along a longitudinal margin of the base and orthogonal to the base, and wherein the angle bracket is attached to the post with attachment hardware.

3. The system of claim 2, wherein the base has elevated slots formed along a longitudinal axis of the base spaced on each side of the post.

4. The system of claim 3, further comprising straps, wherein the elevated slots encircle the straps and the straps are configured to encompass the sailboat boom.

5. The system of claim 1, wherein the laser emitter is self-leveling.

6. A method for mast alignment, comprising:
providing the system of claim 1;
attaching the laser emitter to the mounting bracket assembly;
strapping the mounting bracket assembly to the sailboat boom;
projecting the vertical laser beam on a rear of a sailboat mast; and
adjusting turnbuckles of shrouds and/or stays until the vertical laser beam extends along a center of more than half of a full height of the sailboat mast.

7. The method of claim 6, further comprising:
sliding the mounting bracket assembly along the sailboat boom until the vertical laser beam extends along the full height of the sailboat mast.
